(19) United States
(12) Patent Application Publication
(10) Pub. No.: US 2021/0090593 A1
(43) Pub. Date: Mar. 25, 2021

(54) METHOD AND DEVICE FOR ANALYZING REAL-TIME SOUND

(71) Applicant: DEEPLY INC., Seoul (KR)

(72) Inventors: Myeong Hoon Ryu, Gunpo-Si (KR); Han Park, Seoul (KR)

(21) Appl. No.: 16/491,236

(22) PCT Filed: Nov. 7, 2018
(86) PCT No.: PCT/KR2018/013436

§ 371 Date: Sep. 5, 2019

(30) Foreign Application Priority Data
Jun. 29, 2018 (KR) 10-2018-0075331
Jun. 29, 2018 (KR) 10-2018-0075332

(51) Int. Cl. G10L 25/72; G10L 25/27; G06N 20/00; G10L 25/18

(52) U.S. Cl. CPC G10L 25/72; G10L 25/18; G06N 20/00; G10L 25/27

(57) ABSTRACT

A real-time sound analysis device according to an embodiment of the present disclosure includes: an input unit for collecting a sound generated in real, time, a signal processor for processing the collected real-time sound data for easy machine learning, a first trainer for training a first function for distinguishing sound category information by learning the previously collected sound data in a machine learning manner; and a first classifier for classifying sound data signal processed by the first function into a sound category. According to an embodiment of the present disclosure, it is possible to learn the category and cause of a sound collected in real time based on machine learning, and more accurate prediction of the category and cause of the sound collected in real time is possible.

### REFERENCE TO RELATED APPLICATIONS

This application is a U.S. national stage of PCT/KR2018/013436, filed Nov. 7, 2018, which claims priority from Korean application Nos. KR10-2018-0075331, filed Jun. 29, 2018 and KR10-2018-0075332, filed Jun. 29, 2018, the entire content of all of which is incorporated herein by reference.

### FIELD OF THE INVENTION

The present disclosure relates to a method and a device for analyzing a real-time sound, and more particularly, to a method and device for learning and analyzing an ambient sound generated in real time in a machine learning manner based on artificial intelligence.

### BACKGROUND OF THE INVENTION

With the development of sound technology, various devices having a function of detecting and classifying sounds have been released, The ability to classify sounds and provide results to users through frequency analysis is widely used by people's mobile devices. In recent years, artificial intelligence speakers have been introduced to increase the variety of tools for sound analysis, such as responding to a user's verbal sound and providing appropriate feedback on questions or commands.

Korean Patent No. 10-1092473 provides a method and a device for detecting a baby cry using a frequency and a continuous pattern capable of detecting a baby cry among various sounds in the vicinity. This aims to relieve the burden of parenting by loading feedback functions such as detecting whether the baby is crying and notifying, the parents or automatically listening to the mother's heartbeat. However, such a technique in some cases has a problem of giving inappropriate feedback, such as providing only consistent feedback (e.g. listening to the mother's heartbeat) in spite of various reasons for crying of the baby (e.g., hunger, pain, etc.), because of only no ng whether the baby is crying, but not providing information about why the baby is crying.

Meanwhile, the recently launched artificial intelligence speakers only respond to a verbal sound, so they may not provide feedback on a non-verbal sound (e.g. a baby cry) that cannot be written.

### SUMMARY OF THE INVENTION

Provided are a method and a device capable of analyzing the category and cause of a sound by learning the sound by machine learning to learn the cause of the sound in addition to classifying the sound in real time.

According to an aspect of the present disclosure, a real-time sound analysis device includes: an input unit for collecting a sound generated in real time; a signal processor for processing collected real-time sound data for easy machine learning; a first trainer for training a first function for distinguishing sound category information by learning previously collected sound data in a machine learning manner; and a first classifier for classifying sound data signal processed by the first function into a sound category.

The real-time sound analysis device according to an embodiment of the present disclosure may include: a first communicator for transmitting and receiving information about sound data, wherein the first communicator may transmit the signal processed sound data to an additional analysis device.

The first communicator may receive a result of analyzing a sound cause through a second function trained by deep learning from the additional analysis device.

In an embodiment of the present disclosure, the first trainer may complement the first function by learning the real-time sound data in a machine learning manner.

In an embodiment of the present disclosure, the first trainer may receive feedback input by a user and learn real-time sound data corresponding to the feedback in a machine learning manner to complement the first function.

The real-time sound analysis device according to an embodiment of the present disclosure may further include a first feedback receiver, wherein the first feedback receiver may directly receive feedback from the user or receive feedback from another device or module.

The term ‘function’ in the specification refers to a tool that is continuously reinforced by data and learning algorithms given for machine learning. In more detail, the term ‘function’ refers to a tool for predicting the relationship between an input (sound) and an output (category or cause). Thus, the function may be predetermined by an administrator during the initial learning.

The first function, which is more accurate as more data is learned, may be a useful tool for classifying ambient sounds by category by being trained with the previously collected sound data in a machine learning manner. For example, when a sound of interest is the sound of a patient, the first function may distinguish whether the patient makes a moan, a normal conversation, or a laugh by learning a previously collected patient sound in a machine learning manner. In such a machine learning manner, a classifier may be trained. Preferably, the classifier may be a logistic regression classifier, but is not limited thereto. In other words, a function of the classifier may be trained in a machine learning manner by data to improve performance. This learning process is repeated continuously as real-time sound data, is collected, allowing the classifier to produce more accurate results.

The additional analysis device communicating with the real-time sound analysis device may include a second trainer that complements the second function by learning the real-time sound data in a second machine learning manner. The second function, which is more accurate as more data is learned, may classify the causes of ambient sounds by category by being trained with the previously collected sound data in a machine learning manner. For example, when a sound of interest is the sound of a patient, the second function may classify the sound of the patient by cause to distinguish whether the patient complains of neuralgia, pain from high fever, or discomfort in posture by being trained with a previously collected patient sound in a machine learning manner. Preferably, the second machine learning manner may be a deep learning manner. Preferably, an error backpropagation method may be used in the deep learning manner, but is not limited thereto. This learning process is repeated continuously as the real-time sound data is collected, allowing the classifier to produce more accurate results.

Furthermore, the additional analysis device may use information obtained from the real-time sound analysis device as additional training data. If the first trainer extracts feature vectors from raw data of sounds and use them to classify categories of sounds in a machine learning manner, the second trainer may analyze causes of the sounds more quickly and accurately by repeating the learning considering even the categories as the feature vectors. In machine learning or deep learning, this method is very useful for improving the accuracy of analysis because the more diverse and accurate feature vectors of a learning object are, the faster the learning becomes.

In an embodiment of the present disclosure, the first trainer may complement the first function by learning the real-time sound data in a machine learning manner.

In an embodiment of the present disclosure, the first trainer may receive feedback input by a user and learn real-time sound data corresponding to the feedback in a machine learning manner to complement the first function.

In an embodiment of the present disclosure, the real-time sound analysis device may further include a first feedback receiver, wherein the first feedback receiver may directly receive feedback from the user or receive feedback from another device or module.

In an embodiment of the present disclosure, the real-time sound analysis device may further include a first controller, wherein the first controller determines whether the sound category classified by the first classifier corresponds to a sound of interest and, when the classified sound category corresponds to the sound of interest, may control the signal processed sound data to transmit to an additional analysis device.

In an embodiment of the present disclosure, the first trainer may perform auto-labeling based on semi supervised learning on collected sound data. The auto-labeling may be performed by a certain algorithm or by user feedback. That is, the auto-labeling is performed by algorithms specified in the usual and, when receiving user feedback on an error, performs appropriate labeling of the user feedback on data corresponding to the user feedback, and then trains a function by machine learning.

Preferably, the signal processor performs preprocessing, frame generation, and feature vector extraction.

The preprocessing may include at least one of normalization, frequency filtering, temporal filtering, and windowing,

The frame generation is an step of dividing preprocessed sound data into a plurality of frames in a time domain.

The feature vector extraction may be performed for each single frame of the plurality of frames or for each frame group composed of the same number of frames.

A feature vector extracted by the signal processor may include at least one dimension. That is, one feature vector may be used or a plurality of feature vectors may be used.

The signal processor may perform preprocessing, frame generation, and feature vector extraction of real-time sound data, but may generate only a portion of real-time sound data as a core vector before the preprocessing. Since the volume of real-time sound data is huge, the signal processor may perform the preprocessing, the frame generation, and the feature vector extraction after processing only the necessary core vectors without storing all the original data. The core vector may be transmitted to the additional analysis device.

At least one dimension of the feature vector may include a dimension relating to the sound category. This is because more accurate cause prediction is possible when the second trainer of the additional analysis device that trains the second function for distinguishing a sound cause includes the sound category as a feature vector of sound data. However, the feature vector may include elements other than the sound category, and elements of the feature vector that can be added are not limited to the sound category.

Preferably, a first machine learning manner performed by the real-time sound analysis device includes the least mean square (LMS) and may train the logistic regression classifier using the LMS.

Preferably, a second machine learning manner performed by the additional analysis device is a deep learning manner and may optimize the second function through error backpropagation.

The signal processor may further include a frame group forming step of redefining continuous frames into a plurality of frame groups. A set of frames included in each frame group among the plurality of frame groups is different from a set of frames included in another frame group among the plurality of frame groups, and the time interval between the frame groups is preferably constant.

Extraction of a feature vector and classification of the category and cause of a sound may be performed by using each frame group as a unit.

The first trainer may receive feedback input by a user and learn real-time sound data corresponding to the feedback in a machine learning manner to complement the first function.

To this end, the real-time sound analysis device may include a feedback receiver. The first feedback receiver may directly receive feedback from a user or receive feedback from another device or module.

In an embodiment of the present disclosure, the real-time sound analysis device based on artificial intelligence may further include a feedback receiver, wherein the feedback receiver transmits feedback input by a user to at least one of a first trainer and a second trainer, and the trainer receiving the feedback may complement the corresponding function. For example, the second trainer may use information obtained from the real-time sound analysis device as additional training data.

The real-time sound analysis device may further include a first display unit, and the additional analysis device may further include a second display unit, wherein each display unit may output a sound category and/or a sound cause classified by the corresponding analysis device.

The additional analysis device may be a server or a mobile communication terminal, When the additional analysis device is a server, a second communicator may transmit at least one of the sound category and the sound cause to the mobile communication terminal, and may receive the user feedback, which has been input from the mobile communication terminal, again. When the additional analysis device is a mobile communication terminal, the mobile communication terminal may directly analyze the sound cause, and when the user inputs feedback into the mobile communication terminal, the mobile communication terminal may directly transmit the user feedback to the real-time sound analysis device.

Preferably, when the first communicator receives user feedback regarding the sound category, the first trainer may complement the first classifier by learning sound data corresponding TO the feedback in a first machine learning manner. This learning process allows a classifier to produce more accurate results by continuously repeating a process of collecting real-time sound data and receiving feedback.

Preferably, when the second communicator receives user feedback regarding the sound cause, the second trainer may complement the second classifier by learning sound data corresponding to the feedback in a second machine learning manner. This learning process allows a classifier to produce more accurate results by continuously repeating a process of collecting real-time sound data and receiving feedback.

For example, upon receiving user feedback on the category and sound cause, the first classifier and/or the second classifier may be developed through machine learning and/or deep learning based on the feedback.

The signal processor performs signal processing for easily optimizing the real-time sound data, and after preprocessing the real-time sound data, may divide the preprocessed sound data into a plurality of frames in a time domain and may extract a feature vector from each of the plurality of frames. The preprocessing may be, for example, normalization, frequency filtering, temporal filtering, and windowing.

At least one dimension of the feature vector may be a dimension relating to the sound category information.

Preferably, the second machine learning manner is a deep learning manner, and may develop the second classifier through error backpropagation.

According to an aspect of the present disclosure, a real-time sound analysis method includes: step S110 of training a first function for distinguishing sound category information by learning previously collected sound data in a machine learning manner; step S120 of collecting a sound generated in real time through an input unit; step S130 of signal processing collected real-time sound data to facilitate learning; step S140 of classifying the signal processed real-time sound data into a sound category through the first function; step S150 of determining whether the sound category classified in step S140 corresponds to a sound of interest; step S160 of, when the classified sound category corresponds to the sound of interest, transmitting the signal processed real-time sound data from a real-time sound analysis device to an additional analysis device; and step S190 of compensating the first function by learning the real-time sound data in a machine learning manner.

Preferably, the real-time sound analysis device may include step S170 of receiving a result of analyzing a sound cause through a second function trained by deep learning from the additional analysis device.

In an embodiment of the present disclosure, the real-time sound analysis method may further include step S180 of outputting the presence of the sound of interest and/or an analysis result of the sound of interest to the first display unit D1.

According to an aspect of the present disclosure, a real-time sound analysis method includes: first training step S11 of optimizing a first function for distinguishing sound category information by learning previously collected sound data in a first machine learning manner; second training step S21 of optimizing a second function for distinguishing sound cause information by learning the previously collected sound data in a second machine learning manner; first inference step S12 of collecting real-time sound data by a first analysis device and classifying the real-time sound data into a sound category through the first function; step S20 of transmitting real-time sound data from the first analysis device to a second analysis device; and second inference step S22 of classifying the received real-time sound data into a sound cause through the second function.

The first training step may include step S13 of complementing the first function by learning the real-time sound data in a first machine learning manner. The first function, which is more accurate as more data is learned, may be a useful tool for classifying ambient sounds by category by being trained with the previously collected sound data in a machine learning manner. For example, when a sound of interest is the sound of a patient, the first function may distinguish whether the patient makes a moan, a normal conversation, or a laugh by learning a previously collected patient sound in a machine learning manner. In such a machine learning manner, a classifier may be trained. Preferably, the classifier may be a logistic regression classifier, but is not limited thereto. This learning process is repeated continuously as the real-time sound data is collected, allowing the classifier to produce more accurate results.

The second training step may include step S23 of complementing the second function by learning the real-time sound data in a second machine learning manner. The second function, which is more accurate as more data is learned, may classify the causes of ambient sounds by category by being trained with the previously collected sound data in a machine learning manner. For example, when a sound of interest is the sound of a patient, the second function may classify the sound of the patient by cause to distinguish whether the patient complains of neuralgia, pain from high fever, or discomfort in posture by being trained with a previously collected patient sound in a machine learning manner. Preferably, the second machine learning manner may be a deep learning manner. Preferably, an error backpropagation method may be used in the deep learning manner, but is not limited thereto. This learning process is repeated continuously as the real-time sound data is collected, allowing the classifier to produce more accurate results.

In addition, in step S23 of complementing the second function, information obtained in at least one of the first training step S11, the first inference step S12, and step S13 of complementing the first function may be used as additional training data. If the first training step extracts feature vectors from raw data of sounds and uses them to classify the categories of the sounds by machine learning, the second training step may analyze causes of the sounds more quickly and accurately by repeating the learning considering even the categories as the feature vectors. In machine learning or deep learning, this method is very useful for improving the accuracy of analysis because the more diverse and accurate feature vectors of a learning object are, the faster the learning becomes.

Preferably, the first inference step. S12 may include signal processing step S121 of optimizing the real-time sound data to facilitate machine learning and step S122 of classifying signal processed sound data through the first function. The term ‘function’ in the specification refers to a tool that is continuously reinforced by data and learning algorithms given for machine learning. In more detail, the term ‘function’ refers to a tool for predicting the relationship between an input (sound) and an output (category or cause). Thus, the function may be predetermined by an administrator during the initial learning.

Preferably, the signal processing step may include a preprocessing step, a frame generation step, and a feature vector extraction step.

The preprocessing step may include at least one of normalization, frequency filtering, temporal filtering, and windowing.

The frame generation step may be performed to divide preprocessed sound data into a plurality of frames in a time domain.

The feature vector extraction step may be performed for each single frame of the plurality of frames or for each frame group composed of the same number of frames.

A feature vector extracted in the signal processing step may include at least one dimension. That is, one feature vector may be used or a plurality of feature vectors may be used.

At least one dimension of the feature vector may include a dimension relating to the sound category. This is because more accurate cause prediction is possible when the second training step of distinguishing the sound cause includes the sound category as a feature vector of sound data. However, the feature vector may include elements other than the sound category, and elements of the feature vector that can be added are not limited to the sound category.

Preferably, the first machine learning manner includes LMS and may train the logistic regression classifier using the LMS.

Preferably, the second machine learning manner is a deep learning manner, and may optimize the second function through error backpropagation.

The signal processing step may further include a frame group forming step of redefining continuous frames into a plurality of frame groups. A set of frames included in each frame group among the plurality of frame groups is different from a set of frames included in another frame group among the plurality of frame groups, and the time interval between the frame groups is preferably constant.

The first inference step and the second inference step may be performed by using each frame group as a unit.

According to an aspect of the present disclosure, a real-time sound analysis system includes: a first analysis device and a second analysis device in communication with each other, wherein the first analysis device includes: an input unit for detecting a sound in real time; a signal processor for processing input sound as data; a first classifier for classifying real-time sound data learned by a first trainer and processed by the signal processor by sound category; a first communicator capable of transmitting data collected from the input unit, the signal processor, and the first classifier to the outside; and a first trainer configured to complement a first function for distinguishing sound category information by learning the real-time sound data in a first machine learning manner, and the second analysis device includes: a second communicator receiving data from the first analysis device; a second classifier that is trained ley the second trainer and classifies real-time sound data received from the receiver by sound cause; and a first trainer configured to complement a second function for classifying sound cause information by learning the real-time sound data in a second machine learning manner.

The first analysis device may further include a first display unit, and the second analysis device may further include a second display unit, wherein each display unit may output a sound category and/or a sound cause classified by the corresponding analysis device.

The second analysis device may be a server or a mobile communication terminal. When the second analysis device is a server, the second communicator may transmit at least one of the sound category and the sound cause to the mobile communication terminal, and may receive the user feedback, which has been input from the mobile communication terminal, again. When the second analysis device is a mobile communication terminal, the mobile communication terminal may directly analyze the sound cause, and when the user inputs feedback into the mobile communication terminal, the mobile communication terminal may directly transmit the user feedback to the first analysis device.

Preferably, when the first communicator receives user feedback regarding the sound category, the first trainer may complement the first classifier by learning sound data corresponding to the feedback in a first machine learning manner. This learning process allows a classifier to produce more accurate results by continuously repeating a process of collecting real-time sound data and receiving feedback.

Preferably, when the second communicator receives user feedback regarding the sound cause, the second trainer may complement the second classifier by learning sound data corresponding to the feedback in a second machine learning manner. This learning process allows a classifier to produce more accurate results by continuously repeating a process of collecting real-time sound data and receiving feedback.

For example, upon receiving user feedback on the category and sound cause, the first classifier and/or the second classifier may be developed through machine learning and/or deep learning based on the feedback.

In an embodiment of the present disclosure, the real-time sound analysis device based on artificial intelligence may further include a feedback receiver, wherein the feedback receiver transmits feedback input by a user to at least one of a first trainer and a second trainer, and the trainer receiving the feedback may complement the corresponding function.

For example, the second trainer may use information obtained from e first analysis device as additional training data.

The signal processor performs signal processing for easily optimizing the real-time sound data, and after preprocessing the real-time sound data, may divide the preprocessed sound data into a plurality of frames in a time domain and may extract a feature vector from each of the plurality of frames. The preprocessing may be, for example, normalization, frequency filtering, temporal filtering, and windowing.

At least one dimension of the feature vector may be a dimension relating to the sound category information.

Preferably, the second machine learning manner is a deep learning, manner, and may develop the second classifier through error backpropagation.

According to an embodiment of the present disclosure, it is possible to learn the category and cause of a sound collected in real time based on machine learning, and more accurate prediction of the category and cause of the sound collected in real time is possible.

### BRIEF DESCRIPTION OF DRAWINGS

FIG. 1 is a conceptual diagram illustrating a method and a device for analyzing a real-time sound related to the present disclosure.

FIG. 2 is a view illustrating the first embodiment of a real-time sound analysis device according to an embodiment of the present disclosure.

FIG. 3 is a view illustrating the second embodiment of a real-time sound analysis device according to an embodiment of the present disclosure.

FIG. 4 is a view illustrating the third embodiment of a real-time sound analysis device according to an embodiment of the present disclosure.

FIG. 5 is a block diagram of a real-time sound analysis method according to an embodiment of the present disclosure.

FIG. 6 is an additional block diagram of a real-time sound analysis method according to an embodiment of the present disclosure.

FIG. 7 is a block diagram relating to signal processing of sound data.

FIG. 8 is a view illustrating an embodiment of extracting feature vectors by classifying sound data by frame.

### DETAILED DESCRIPTION OF THE INVENTION

Hereinafter, embodiments of the present disclosure will be described in detail with reference to the accompanying drawings. The same reference numerals are used to denote the same or similar elements regardless of the reference numerals of the drawings reference numerals, and repeated descriptions thereof will be omitted. The suffixes “module” and “unit” for elements used in the following description are given or mixed to facilitate the writing of the specification and do not, by themselves, have a meaning or role that is distinct from each other. In addition, in the following description of the embodiments disclosed herein, a detailed explanation of known related technologies may be omitted to avoid unnecessarily obscuring the subject matter of the embodiments disclosed herein. Furthermore, the accompanying drawings are intended to facilitate understanding of the embodiments disclosed herein, and the technical spirit disclosed herein is not limited by the accompanying drawings. Also, it should be understood that the present disclosure covers all the modifications, equivalents, and replacements within the idea and technical scope of the present disclosure.

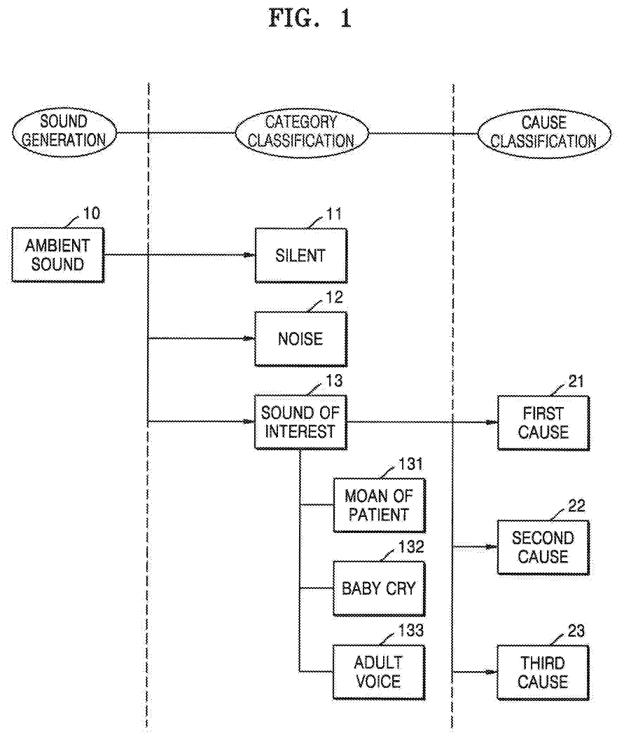

FIG. 1 is a conceptual diagram illustrating a method and a device for analyzing a real-time sound related to the present disclosure.

When an ambient sound 10 occurs, it is detected in real time through an input unit 610 such as a microphone and stored as data. The ambient sound 10 may be a silent 11 with little sound, a sound that is not of interest, to the user, that is, a noise 12, or a sound of interest 13 that the user wants to classify or analyze. The sound of interest 13 may be a moan 131 of a patient, a baby cry 132, or an adult voice 133, However, the sound of interest 13 is not limited to the above three examples, and may be any sound such as a traffic accident collision sound, a vehicle step sound, an animal sound, and the like.

For example, when the sound of interest 13 is the adult voice 133, the baby cry 132 may be classified as the noise 12. For example, when the sound of interest 13 is an animal sound, the patient's moan 131, the baby cry 132, the adult voice 133, and the traffic accident collision sound may be classified as the noise 12.

The classification of the sound category may be performed by a first classifier 630 in a real-time sound analysis device 600. The first classifier 630 may be enhanced in function in a machine learning manner through a first trainer 650. First, the sound category is labeled in at least a portion of previously collected sound data S001. Thereafter, the first trainer 650 trains a first function f1 of the first classifier 630 in a machine learning manner by using the previously collected sound data S001 labeled with the sound category. The first classifier 630 may be a logistic regression classifier.

Supervised learning is one of machine learning manners for training a function using training data. The training data generally includes properties of an input object in the form of a vector, indicating a desired result for each vector. Continuous output of these trained functions is called regression, and labeling what kind of value a given input vector is called classification. Meanwhile, unsupervised learning, unlike the supervised learning, is not given a target value for an input value.

Preferably, in an embodiment of the present disclosure, the first trainer 650 may use semi-supervised learning having an intermediate characteristic between supervised learning and unsupervised learning. The semi-supervised learning refers to the use of both data with and without target values for training. In most cases, training data used in these methods has few pieces of data with a target value and many pieces of data with no target value. The semi-supervised learning may save a lot of time and money for labeling.

A step of marking the target value is called labeling. For example, if the ambient sound 10 is generated and sound data thereof is said to be input, then it is a labeling step to indicate whether a category of the sound is the silent 11, noise 12, or sound of interest 13. In other words, the labeling is a basic step of marking an example of output on data in advance and training a function with the data by a machine learning algorithm.

It is supervised learning that a person directly marks a target value, it is unsupervised learning that a person does not mark the target value, and it is semi-supervised learning that a person marks a portion of the target value directly and does not mark the remaining.

In an embodiment of the present disclosure, a first analysis device 600 may perform auto-labeling based on semi-supervised learning. Label means result values that a function should output. For example, the label is result values of a silent, a noise, a baby cry, baby sounds except the baby cry, and the like. The auto-labeling may be performed in the following order. The auto-labeling may be performed by, for example, the first trainer 650.

First, a person intervenes and labels a certain number of data (e.g., 100). Afterwards, collected sound data is not labeled but rather reduced in dimension after proper signal processing. A clustering technique for classifying homogeneous groups is used to group pieces of data classified into one homogeneity into one data group. Here, the clustering technique performs classification based on a predetermined hyperparameter, but the hyperparameter may be changed according to learning accuracy to be performed in the future.

Next, when a plurality of data groups are formed, only a predetermined number (e.g., four pieces of data) of each data group is randomly selected to determine what features the pieces of data have. For example, when three or more of the four pieces of data selected from a first data group are found to correspond to noise, the first data group considers all data as noise and labels all data in the first data group as noise. If less than two of the four pieces of data selected from a second data group correspond to a baby cry, all data in the second data group are labeled as a noise or silent.

Next, labeling is performed using this predetermined algorithm, and the labeled data is used as training data. In this case, labeling is continued with the algorithm when the accuracy indicator is high, and when the accuracy indicator is low, the dimension reduction or a parameter of clustering is changed, and the above process is performed again.

Meanwhile, although the real-time sound analysis device 600 provides convenience to a user 2 by detecting and displaying the sound of interest 13, the user 2 is a human with hearing and may recognize whether a patient is moaning or not, whether a baby is crying or not, and whether an animal is making a sound or not. These sounds are distinguishable elements if one of the five senses of human hearing is not impaired. However, when a patient makes a moan, it is difficult for the user 2 to know which part hurts and the patient moans with only the moan. Similarly, it is difficult for the user 2 to know what the baby wants when the baby is crying.

When the sound of interest 13 is detected, the real-time sound analysis device 600 transmits signal processed real-time sound data to an additional analysis device 700. There may be various causes of the sound of interest 13 including a first cause, a second cause, and a third cause, and a demand of the user 2 is concentrated on the causes of the sound of interest 13.

For example, when the sound of interest 13 is the baby cry 132, the baby may have cried because he or she was hungry, because he or she wanted to poo or pee, because of discomfort after pooping or peeing in a diaper, or because he or she was sleepy. Alternatively, the baby may have cried sadly, depending on his or her emotional state, or may have cried with joy. As such, the baby cry may sound similar to an adult, but there are a variety of causes.

For example, when the sound of interest 13 is the moaning 131 of a patient, according to an embodiment of the present disclosure, it is possible to early detect a specific disease that is difficult to detect through various sounds generated from the voice of the patient. In addition, various sounds generated from the patient's body instead of the patient's moaning 131 may also be the sound of interest 13. In more detail, after detecting a peeing sound of the patient as the sound of interest 13 by the real-time sound analysis device 600, the additional analysis device 700 may analyze whether the patient is suffering from an enlarged prostate.

For example, when the sound of interest 13 is a bearing friction sound, according to an embodiment of the present disclosure, it is possible to early detect defects that may cause an accident through various sounds generated while a bearing rotates.

The classification of a sound cause may be performed by the second classifier 710 in the additional analysis device 700. The second classifier 710 may be enhanced in function in a deep learning manner through a second trainer 750. First, the sound cause is labeled in at least a portion of the previously collected sound data S001. Thereafter, the second trainer 750 trains a second function f2 of the second classifier 710 in a deep learning manner by using the previously collected sound data S001 labeled with the sound cause.

By communication between the real-time sound analysis device 600 and the additional analysis device 700, the user 2 may determine whether the sound of interest 13 is generated and causes 21, 22, and 23 of the sound of interest 13.

In an embodiment of the present disclosure, the sound cause may be a state of a subject that generates a sound. That is, if a ‘cause’ of a baby cry is hungry, the baby is in a hungry ‘state’. The term ‘state’ may be understood as a primary meaning that the baby is crying, but data to be obtained by the additional analysis device 700 of the embodiment of the present disclosure has a secondary meaning such as the reason why the baby is crying.

In an embodiment of the present disclosure, the real-time sound analysis device 600 may improve analysis accuracy of a state (a sound cause) of an analysis target by detecting information other than a sound and performing analysis together with the sound. For example, the real-time sound analysis device 600 may further perform analysis by detecting vibration generated when a baby is turned over. Accordingly, a device for detecting vibration may further be provided. Alternatively, a module for detecting vibration may be mounted on the real-time sound analysis device 600. The device for detecting vibration is just an example, and any device for detecting information related to the set sound of interest 13 may be added.

In an embodiment of the present disclosure, the real-time sound analysis device 600 may improve analysis accuracy of a state (a sound cause) of an analysis target by detecting a plurality of sounds of interest 13 and performing analysis together with the sounds.

For example, when a baby cry is detected after someone falls and bumps and the device only analyzes the baby cry, the probability that the cause is analyzed as “pain” may be low (e.g., 60%), However, when the device analyzes information that the falling sound and the bumping sound occur just before the baby cry together with the baby cry, the probability that the cause is analyzed as “pain” may be higher (e.g., 90%). That is, reliability of the device may be improved.

In an embodiment of the present disclosure, the real-time sound analysis device 600 is preferably placed near an object for which the user 2 wants to detect sound. Therefore, the real-time sound analysis device 600 may require mobility, and its data storage capacity may be less. That is, in the case of a small (or ultra-small) device such as a sensor included in a device that needs to be moved, computing resources (memory usage, CPU usage), network resources, and battery resources are generally very low compared to a general desktop computer or server environments, That is, when the ambient sound 10 occurs after the real-time sound analysis device 600 is disposed, it is preferable that only essential information necessary for artificial intelligence analysis, in particular machine learning or deep learning, is stored among the original data.

For example, the size of a microcontroller unit (MCU) based processor is only about one-hundreds of thousands of the size of a processor used by a desktop computer. In particular, in the case of media data such as sound data, the size of the data is so great that the MCU-based processors cannot store and process original data in a memory like a desktop computer. For example, four-minute voice data (44.1 KHz sampling rate) is typically about 40 MB in size, but the total memory capacity of a high-performance MCU system is only 64 KB, which is about one-600th of that of a desktop computer.

Therefore, the real-time sound analysis device 600 according to an embodiment of the present disclosure, unlike the conventional method of storing and processing the original data to be analyzed in the memory, performs intermediate processing on the original data (e.g., FFT, arithmetic computation, etc.) first, and then generates only some information necessary for an artificial intelligence analysis process as a core vector.

The core vector, which is different from preprocessing and a feature vector, does not go through a process of preprocessing the original data in real time and using the result to perform a feature vector calculation immediately. In more detail, the real-time sound analysis device 600 stores a preprocessing intermediate calculation value and an intermediate calculation value of the original data required for the calculation of a feature vector to be obtained later. This is not strictly a compression of the original data.

Therefore, the core vector calculation is performed before the preprocessing and feature vector extraction, and the real-time sound analysis device 600 may overcome limitations of insufficient computational power and a storage space by storing the core vector instead of the original data.

Preferably, data transmitted from the real-time sound analysis device 600 to the additional analysis device 700 (or to another device) may be core vector information of the real-time sound data. That is, since an step of transmitting a sound collected in real time to the additional analysis device 700 (or to another device) also needs to be performed in real time, it is advantageous to transmit only core vector information: generated by a signal processor of the real-time sound analyzer 600 to the additional analysis device 700.

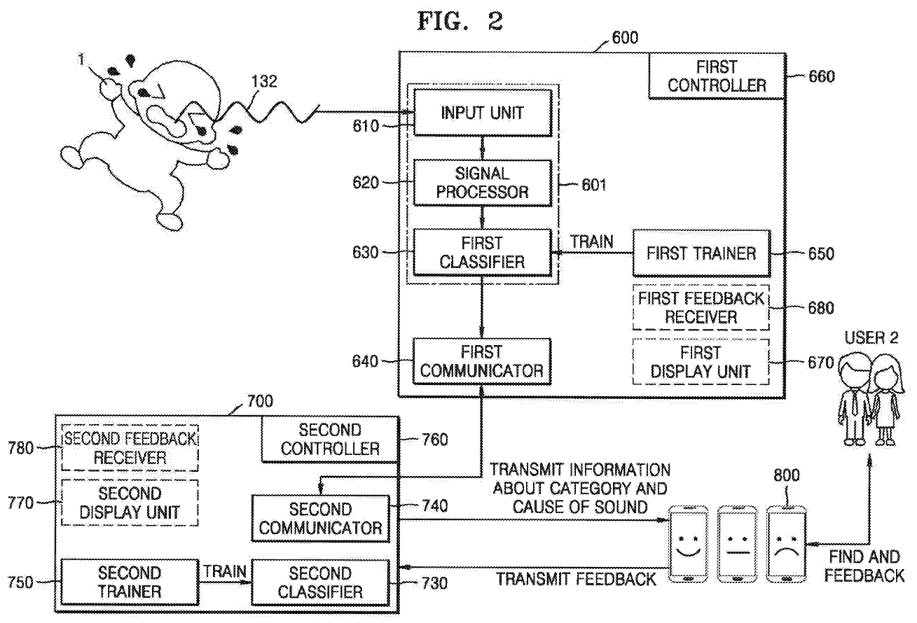

Hereinafter, interactions between a sound source 1, the real-time sound analysis device 600, the additional analysis device 700, a mobile communication terminal 800, and the user 2 will be described in detail with reference to FIGS. 2 to 5.

FIG. 2 is a view illustrating the first embodiment of a real-time sound analysis device according to the present disclosure.

The sound source 1 may be a baby, an animal, or an object. FIG. 2 shows a crying baby. For example, when the baby cry 132 is detected by an input unit 610, the baby cry 132 is stored as real-time sound data S002 and is signal processed by a signal processor 620 for machine learning. The signal processed real-time sound data is classified into a sound category by the first classifier 630 including the first function f1.

The real-time sound data classified into a sound category by the first classifier 630 is transmitted to the additional analysis device 700 by communication between a first communicator 640 and a second communicator 740. Data related to a sound of interest among the transmitted real-time sound data are classified by a second classifier 730 as a sound cause.

The first trainer 650 trains the first function f1 of the first classifier 630 by machine learning. Where an input is the ambient sound 10 and an output is a sound category. The sound category includes the silent 11, the noise 12, and the sound of interest 13, but other categories may be included. For example, the sound category may include the silent 11, the noise 12, the first sound of interest, the second sound of interest, and the third sound of interest for a plurality of sounds of interest. For example, the silent 11 and the noise 12 may be changed to other categories.

The first classifier 630 includes the first function f1 trained using the previously collected sound data S001. That is, pre-training is perfumed so that real-time sound data that is the input may be classified into the sound category that is the output through the first function f1. However, since the first function f1 is not perfect even if the pre-training is performed, it is desirable to continuously complement the first function f1. After the real-time sound data S002 is continuously introduced and a result value thereof is output, when the user 2 inputs feedback on erroneous results, the first trainer 650 reflects the feedback and trains the first classifier 630 again. As this process is repeated, the first function f1 is gradually complemented, and sound category classification accuracy is improved.

The second classifier 730 includes the second function f2 trained using the previously collected sound data S001. That is, pre-training is performed so that real-time sound data that is the input may be classified into sound cause that is the output through the second function f2. However, since the second function f2 is not perfect even if pre-training is performed, it is desirable to continuously complement the second function f2. After the real-time sound data S002 is continuously introduced and a result value thereof is output, when the user 2 inputs feedback on erroneous results, the second, trainer 750 reflects the feedback and trains the second classifier 730 again. As this process is repeated, the second function f2 is gradually complemented, and sound cause classification accuracy is improved.

The real-time sound analysis device 600 may include a first display unit 670. The first display unit 670 maybe, for example, a light, a speaker, a text display unit, and a display panel. The first display unit 670 may display a sound category, and may preferably display a sound cause received from the additional analysis device 700.

The additional analysis device 700 may include a second display unit 770. The second display unit 770 may be, for example, a light, a speaker, a text display unit, and a display panel. The second display unit 770 may display a sound cause, and may preferably display the sound category received from the real-time sound analysis device 600.

Components of the real-time sound analysis device 600 are controlled by a first controller 660. When the ambient sound 10 is detected by the input unit 610, the first controller 660 may issue a command to the signal processor 620 and the first classifier 630 to execute signal processing and classification, and may transmit a command to the first communicator 640 to transmit a classification result and the real-time sound data to the additional analysis device 700. In addition, according to inflow of real-time sound data, it may be determined whether the first trainer 650 performs training to complement the first classifier 630. In addition, the first controller 660 may control to display a classification result on the first display unit 670.

Components of the additional analysis device 700 are controlled by a second controller 760. When receiving data from the real-time sound analysis device 600, the second controller 760 may issue a command to the second classifier 730 to perform classification, and may transmit a command to the second communicator 740 to transmit a classification result to the real-time sound analysis device 600. In addition, according to inflow of real-time sound data, it may be determined whether the second trainer 750 performs training to complement the second classifier 730. In addition, the second controller 760 may control to display a classification result on the second display unit 770.

The user 2 is provided with an analysis of the category and cause of a sound through an application installed in the mobile communication terminal 800. That is, the real-time sound analysis device 600 transmits real-time sound data that is signal processed by the first communicator 640 and a sound category classification result to the second communicator 740, and the additional analysis device 700 classifies a sound causes based on the received data. Thereafter, the additional analysis device 700 transmits results of analyses performed by the real-time sound analysis device 600 and the additional analysis device 700 to the mobile communication terminal 800, and the user 2 may access the results of analyses through the application.

The user 2 may provide feedback through the application as to whether the results of analyses are correct or not, and the feedback is transmitted to the additional analysis device 700. The real-time sound analysis device 600 and the additional analysis device 700 share the feedback and retrain the corresponding functions f1 and f2 by the controllers 660 and 760. That is, the feedback is reflected and labeled in real-time sound data corresponding to the feedback, and the trainers 650 and 750 train the classifiers 630 and 730 to improve the accuracy of each function.

In the embodiment of FIG. 2, the additional analysis device 700 may be a server.

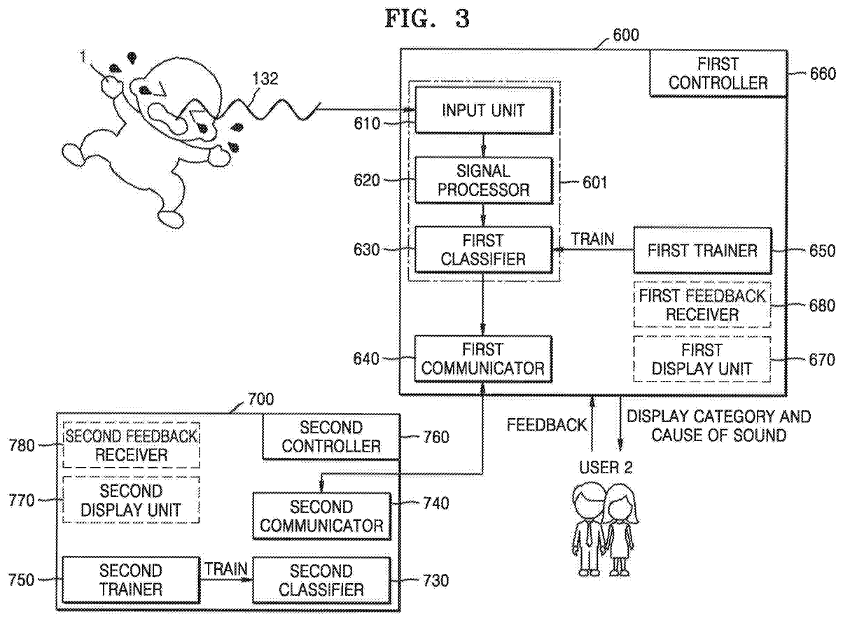

FIG. 3 is a view illustrating the second embodiment of a real-time sound analysis device according to the present disclosure. In FIG. 3, the same reference numerals as in FIG. 2 denote the same elements, and therefore, repeated descriptions thereof will not be given herein.

The user 2 may receive an analysis result of the category and cause of the sound directly from the real-time sound analysis device 600. The analysis result may be provided through the first display unit 670. The user 2 may provide feedback to the real-time sound analysis device 600 as to whether the analysis result is correct or not, and the feedback is transmitted to the additional analysis device 700, The real-time sound analysis device 600 and the additional analysis device 700 share the feedback and retrain the corresponding functions f1 and f2 by the controllers 660 and 760. That is, the feedback is reflected and labeled in real-time sound data corresponding to the feedback, and the trainers 650 and 750 train the classifiers 630 and 730 to improve the accuracy of each function.

In the embodiment of FIG. 3, the additional analysis device 700 may be a server.

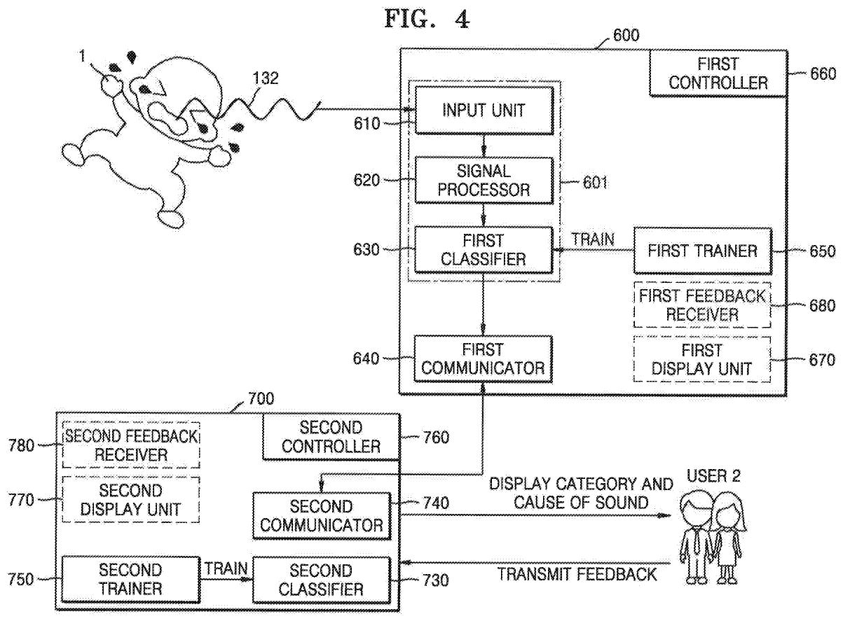

FIG. 4 is a view illustrating the third embodiment of a real-time sound analysis device according to the present disclosure. In FIG. 4, the same reference numerals as in FIG. 2 denote the same elements, and therefore, repeated descriptions thereof will not be given herein.

The user 2 may receive an analysis result of the category and cause of a sound directly from the additional sound analysis device 600. The analysis result may be provided through the second display unit 770. The user 2 may provide feedback to the additional sound analysis device 700 as to whether the analysis result is correct or not, and the feedback is transmitted to the real-time analysis device 600. The real-time sound analysis device 600 and the additional analysis device 700 share the feedback and retrain the corresponding functions f1 and f2 by the controllers 660 and 760. That is, the feedback is reflected and labeled in real-time sound data corresponding to the feedback, and the trainers 650 and 750 train the classifiers 630 and 730 to improve the accuracy of each function.

In the embodiment of FIG. 4, the additional analysis device 700 may be a portion of a mobile communication terminal. That is, the mobile communication terminal 800 may include the additional analysis device 700, and in this case, the user 2 may directly input feedback to the additional analysis device 700.

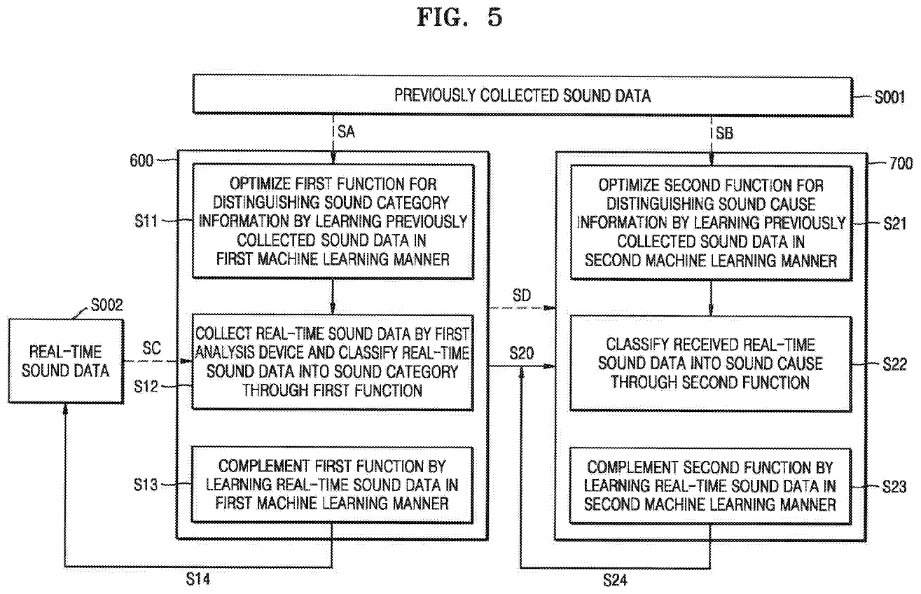

FIG. 5 is a block diagram of a real-time sound analysis method according to an embodiment of the present disclosure.

The real-time sound analysis method and a system thereof according to the present disclosure operate by interaction between the first analysis device 600 and the second analysis device 700. The previously collected sound data S001 may be collected by a crawling method, but is not limited thereto. In order to allow each of the classifiers 630 and 730 to perform a minimum function, previously collected sound data S001 in which at least a portion of each of the first trainer 650 of the first analyzer 600 and the second trainer 750 of the second analyzer 700 is labeled are required. The previously collected sound data S001 is transmitted to each of the analysis devices 600 and 700 (SA and SB). An step of training the first function f1 and the second function f2 by this previously collected sound data S001 is preceded by a classification step.

After training the functions with the previously collected sound data S001 and then real-time sound data 5002 is input SC, the first analysis device 600 extracts a feature vector after signal processing and classifies the real-time sound data into a sound category. The second analysis device 700 receives the real-time sound data classified into the sound category from the first analysis device 600 and classifies the real-time sound data into a sound cause through the second function.

When the classification step is completed in each of the analysis devices 600 and 700, the functions f1 and f2 are complemented.

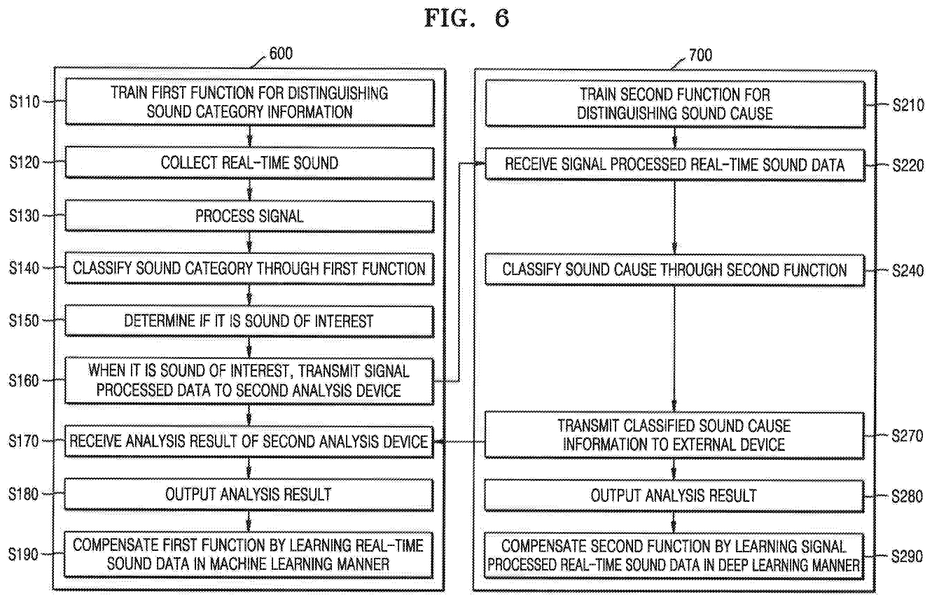

FIG. 6 is another block diagram of a real-time sound analysis method according to an embodiment of the present disclosure. FIG. 6 shows an order in which the real-time sound analysis device 600 and the additional analysis device 700 are operated, and the relationship of the steps associated with each other. If FIG. 5 is shown centered on a device, FIG. 6 is shown centered on a method.

After the real-time sound data S002 is input through the input unit 610 after the first function f1 and the second function f2 are optimized to some extent by training, a signal processing step S130 including preprocessing and feature vector extraction is performed. Thereafter, the real-time sound data S002 is classified by sound category through the first function f1.

A sound category may include the silent 11 and the noise 12, and at least one of which may be designated as the sound of interest 13 of a user. For example, the sound of interest 13 may be a baby cry, and the sound of interest 13 may be a baby cry and a parents' voice.

The first controller 660 may determine whether a classified sound category corresponds to the sound of interest. If the classified sound category corresponds to the sound of interest, the signal processed real-time sound data is transmitted from the real-time sound analysis device 600 to the additional analysis device.

The second communicator 740 receiving the signal processed real-time sound data transmits this information to the second classifier 730, and the second classifier 730 classifies the information by sound cause through the second function f2.

A result of the sound cause classification may be transmitted to an external device. The external device may be the real-time sound analysis device 600, but may be another device.

After transmitting the result of the sound cause classification through the second communicator 740 to the first communicator 640, a display unit of each of the analysis devices 600 and 700 may output an analysis result of a sound category and/or a sound cause.

After going through a series of processes, the first trainer 650 may complement the first function by learning collected real-time sound data in a machine learning manner. In this case, when user feedback is received, it is preferable to improve the first function by learning real-time sound data corresponding to the feedback in a machine learning manner.

After going through a series of processes, the second trainer 750 may complement the second function by learning the collected real-time sound data in a deep learning manner. In this case, when user feedback is received, it is preferable to improve the second function by learning real-time sound data, corresponding to the feedback in a deep learning manner.

The real-time sound analysis device 600 extracts a feature vector after signal processing and classifies the real-time sound data into a sound category through the second function. The additional analysis device 700 receives the real-time sound data classified into the sound category from the real-time sound analysis device 600 and classifies the real-time sound data into a sound cause through the second function. When the classification step is completed in each of the analysis devices 600 and 700, the functions f1 and f2 may be complemented.

In the embodiment of the present disclosure, when the sound of interest 13 is a simple baby sound instead of the baby cry 132, the method and device for analyzing the real-time sound according to the present disclosure may provide more useful information to the user 2.

That is, a baby may make a pre-crying sound before crying, and if the sound of interest 13 is the pre-crying sound, the user 2 is provided with analysis for a category and a cause of the pre-crying sound, and thus a taster response is possible than if the user 2 is provided with analysis for the baby cry after crying.

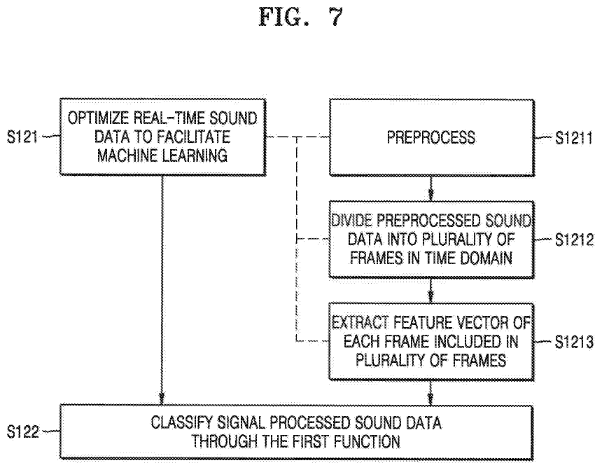

FIG. 7 is a block diagram relating to signal processing of sound data.

The signal processor 620 optimizes real-time sound data to facilitate machine learning. The optimization may be performed by signal processing.

Preferably, the signal processor 620 may perform preprocessing such as normalization, frequency filtering, temporal filtering, and windowing, may divide the preprocessed sound data into a plurality of frames in a time domain, and may extract a feature vector of each frame or a frame group.

The real-time sound data represented by a feature vector may configure one unit for each frame or for each frame group.

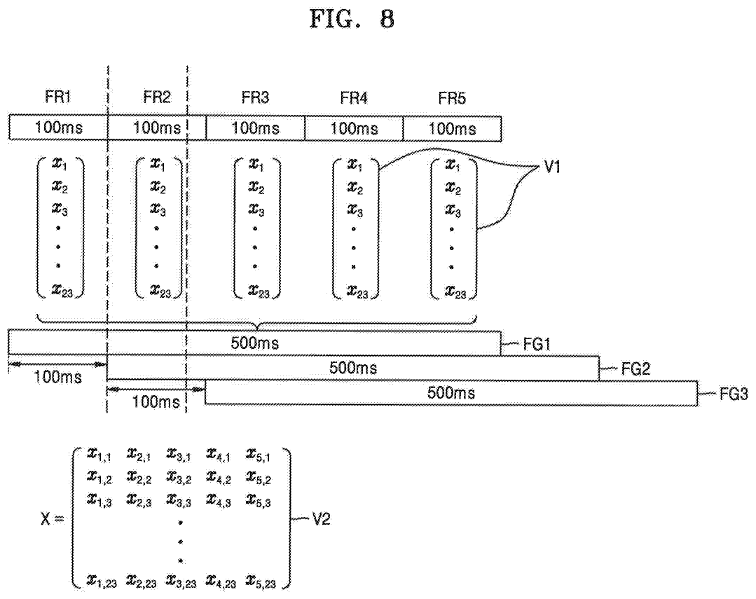

FIG. 8 is a view illustrating an embodiment of extracting feature vectors by classifying sound data by frame.

Each of frames FR1, FR2, FR3, FR4, and FRS cut in 100 ms units in a time domain is defined, and a single frame feature vector V1 is extracted therefrom. As shown in FIG. 8, five continuous frames are bundled and defined as one frame group FG1, FG2, and FG3, and from which a frame group feature vector V2 is extracted. Although analysis may be performed for each single frame, analysis may be performed for each frame group FG1, FG2, and FG3 in order to prevent overload due to data processing and to improve accuracy.

1. A reel-time sound analysis device based on artificial intelligence, the real-time sound analysis device comprising:
an input unit configured to collect a sound generated in real time;
a signal processor configured to process collected real-time sound data for easy machine learning;
a first trainer configured to train a first function for distinguishing sound category information by learning previously collected sound data in a machine learning manner; and
a first classifier configured to classify sound data signal processed by the first function into a sound category.

2. The real-time sound analysis device of claim 1, comprising:
a first communicator configured to transmit and receive information about sound data,
wherein the first communicator transmits the signal processed sound data to an additional analysis device.

3. The real-time sound analysis device of claim 2, wherein the first communicator receives a result of analyzing a sound cause through a second function trained by deep learning from the additional analysis device.

4. The real-time sound analysis device of claim 1, wherein the first trainer complements the first function by learning the real-time sound data in a machine learning manner.

5. The real-time sound analysis device of claim 4, wherein the first trainer receives feedback input by a user and learns real-time sound data corresponding to the feedback in a machine learning manner to complement the first function.

6. The real-time sound analysis device of claim 5, further comprising:
a first feedback receiver,
wherein the first feedback receiver directly receives feedback from the user or receives feedback from another device or module.

7. The real-time sound analysis device of claim 1, further comprising:
a first controller.
wherein the first controller determines whether the sound category classified by the first classifier corresponds to a sound of interest and, when the classified sound category corresponds to the sound of interest, controls the signal processed sound data to transmit to an additional analysis device.

8. The real-time sound analysis device of claim 1, wherein the signal processor performs preprocessing, frame generation, and feature vector extraction of real-time sound data, but generates only a portion of real-time sound data as a core vector before the preprocessing.

9. The real-time sound analysis device of claim 1, wherein the first trainer performs auto-labeling based on semi-supervised learning on collected sound data.

10. The real-time sound analysis device of claim 9, wherein the auto-labeling is performed by a certain algorithm or by user feedback.

11. A real-time sound analysis method based on artificial intelligence, the real-time sound analysis method comprising the steps of;
training a first function for distinguishing sound category information by learning previously collected sound data in a machine learning manner;
collecting a sound generated in real time through an input unit;
signal processing collected real-time sound data to facilitate learning;
classifying the signal processed real-time sound data into a sound category through the first function;
determining whether the sound category classified in the step of classifying corresponds to a sound of interest; transmitting the signal processed real-time sound data from a real-time sound analysis device to an additional analysis device when the classified sound category corresponds to the sound of interest; and
compensating the first function by learning the real-time sound data in a machine learning manner.

12. The real-time sound analysis method of claim 11, further comprising:
receiving a result of analyzing a sound cause through a second function trained by deep learning from the additional analysis device to the real-time sound analysis device.

13. A real-time sound analysis method based on artificial intelligence, the real-time sound analysis method comprising the steps of:
optimizing a first function for distinguishing sound category information by learning previously collected sound data in a first machine learning manner;
optimizing a second function for distinguishing sound cause information by learning the previously collected sound data in a second machine learning manner;
classifying real-time sound data collected by a first analysis device into a sound category through the first function;
transmitting real-time sound data from the first analysis device to a second analysis device; and
classifying the received real-time sound data into a sound cause through the second function.

14. The real-time sound analysis method of claim 13, further comprising:
complementing the first function by learning the real-time sound data in a first machine learning manner.

15. The real-time sound analysis method of claim 14, further comprising:
complementing the second function by learning the real-time sound data in a second machine learning manner.

16. The real-time sound analysis method of claim 15, wherein, in the step of complementing the second function, information obtained in at least one step of optimizing the first function, classifying the real-time sound data, and complementing the first function is used as additional training data.

17. The real-time sound analysis method of claim 13, wherein the step of classifying the real-time sound data comprises:
optimizing the real-time sound data to facilitate machine learning; and
of classifying signal processed sound data through the first function.

18. The real-time sound analysis method of claim 17, wherein the step of optimizing the real-time sound data comprises:
preprocessing the real-time sound data;
dividing preprocessed sound data into a plurality of frames in a time domain; and
extracting a feature vector of each frame included in the plurality of frames.

19. The real-time sound analysis method of claim 18, wherein at least one of dimensions constituting the feature vector is a dimension related to the sound category information.

20. The real-time sound analysis method of claim 19, wherein the second machine learning manner is a deep learning manner, wherein the deep learning manner optimizes the second function through error backpropagation.
